(19) United States
(12) Patent Application Publication
(10) Pub. No.: US 2007/0046582 A1
(43) Pub. Date: Mar. 1, 2007

(54) Plasma display apparatus and method of driving the same

(75) Inventors: Dongki Paik, Seoul (KR); Jongrae Lim, Anyang-si (KR); Tae Heon Kim, Seoul (KR); Wootae Kim, Yongin-si (KR); Sung Chun Choi, Anyang-si (KR)

Correspondence Address: FLESHNER & KIM, LLP, P.O. BOX 221200, CHANTILLY, VA, 20153, US

(73) Assignee: LG Electronics Inc.

(21) Appl. No.: 11/507,574

(22) Filed: Aug. 22, 2006

(30) Foreign Application Priority Data
Aug. 23, 2005 (KR) 10-2005-0077032

(51) Int. Cl. G09G 3/28

(52) U.S. Cl. 345/68

(57) ABSTRACT

A plasma display apparatus and a method of driving the same are disclosed. The plasma display apparatus includes an energy storing unit, a first energy recovery circuit unit and a second energy recovery circuit unit. The energy storing unit recovers a voltage stored in each of a scan electrode and a sustain electrode of a plasma display panel. The first energy recovery circuit unit recovers the voltage stored in the scan electrode, stores the recovered voltage in the energy storing unit, and supplies the voltage stored in the energy storing unit to the scan electrode. The second energy recovery circuit unit recovers the voltage stored in the sustain electrode, stores the recovered voltage in the energy storing unit, and for supplies the voltage stored in the energy storing unit to the sustain electrode.

This Nonprovisional application claims priority under 35 U.S.C. § 119(a) on Patent Application No. 10-2005-0077032 filed in Korea on Aug. 23, 2005 the entire contents of which are hereby incorporated by reference.

### BACKGROUND OF THE INVENTION

1. Field of the Invention

This document relates to a display apparatus, and more particularly, to a plasma display apparatus and a method of driving the same.

2. Description of the Background Art

Out of display apparatuses, a plasma display apparatus comprises a plasma display panel and a driver for driving the plasma display panel.

The plasma display panel comprises a front panel, a rear panel and barrier ribs formed between the front panel and the rear panel. The barrier ribs form unit discharge cell or discharge cells. Each of the discharge cell is filled with a main discharge gas such as neon (Ne), helium (He) and a mixture of Ne and He, and an inert gas containing a small amount of xenon (Xe).

The plurality of discharge cells form one pixel. For example, a red (R) discharge cell, a green (G) discharge cell and a blue (B) discharge cell form one pixel.

When the plasma display panel is discharged by a high frequency voltage, the inert gas generates vacuum ultra-violet rays, which thereby cause phosphors formed between the barrier ribs to emit light, thus displaying an image. Since the plasma display panel can be manufactured to be thin and light, it has attracted attention as a next generation display device.

FIGS. 1a and 1b illustrate an energy recovery circuit and a driving waveform of a related art plasma display apparatus.

As illustrated in FIG. 1a, the energy recovery circuit of the related art plasma display apparatus comprises first to fourth switches S1, S2, S3 and S4 connected to a plasma display panel Cp, an energy recovery capacitor Cs and an inductor L. An operation of the energy recovery circuit will be described through the following four states.

Referring to FIGS. 1a and 1b, in a first state (State 1), the first switch S1 is turned on and the second to fourth switches S2 to S4 are turned off. As a result, as an energy stored in the energy recovery capacitor Cs is supplied to the plasma display panel Cp, a voltage of the plasma display panel Cp gradually rises. Since the energy is supplied from the capacitor Cs to the plasma display panel Cp in the first state (State 1), a current flowing in the inductor L is +L.

In a second state (State 2), the first switch S1 and the second switch S2 are turned on and the third switch S3 and the fourth switch S4 are turned off. As a result, a voltage of the plasma display panel Cp is equal to a sustain voltage Vs by a voltage supplied through the second switch S2.

More specifically, the moment the first state (State 1) ends, that is, at a time point t1 when a voltage of the plasma display panel Cp is maximum due to LC resonance, the sustain voltage Vs is supplied to the plasma display panel Cp. A voltage of the plasma display panel Cp is maintained at the sustain voltage Vs during the second state (State 2).

In a third state (State 3), the third switch S3 is turned on and the first, second and fourth switches S1, S2 and S4 are turned off. As a result, energy stored in the plasma display panel Cp is discharged such that the energy recovery capacitor Cs recovers the discharged energy. Therefore, a voltage of the plasma display panel Cp gradually falls.

Since the energy is supplied from the plasma display panel Cp to the energy recovery capacitor Cs in the third state (State 3), a current flowing in the inductor L is −IL of an inverse direction.

In a fourth state (State 4), the third switch S3 and the fourth switch S4 are turned on, and the first switch S1 and the second switch S2 are turned off. As a result, a voltage of the plasma display panel Cp is equal to a ground level voltage.

More specifically, the moment the third state (State 3) ends, that is, at a time point t2, the ground level voltage is supplied to the plasma display panel Cp. A voltage of the plasma display panel Cp is maintained at the ground level voltage during the fourth state (State 4).

Recently, a negative sustain method has been used as a driving method of a plasma display apparatus using low power. In the negative sustain method, before generating a surface discharge between a scan electrode and a sustain electrode, an opposite discharge occurs between the scan electrode or the sustain electrode and an address electrode. Charges generated by the opposite discharge functions as a seed charge of the surface discharge such that the surface discharge occurs smoothly.

When the related art energy recovery circuit of FIG. 1a, in which the energy recovery capacitor Cs and a negative sustain voltage source are connected to each other, operates using the negative sustain method, the reactive energy can be recovered from the plasma display panel Cp.

However, the related art energy recovery circuit using the negative sustain method comprises both a scan driving circuit for the scan electrode and a sustain driving circuit for the sustain electrode. Therefore, the scan driving circuit and the sustain driving circuit having the same configuration are disposed duplicately such that the energy recovery circuit is complicated and causes an increase in price.

### SUMMARY OF THE INVENTION

Accordingly, an object of the present invention is to solve at least the problems and disadvantages of the background art.

An embodiment of the present invention provides a plasma display apparatus and a method of driving the same capable of simplifying the configuration of a circuit and reducing the cost.

In an aspect, there is provided a plasma display apparatus comprising a plasma display panel comprising a scan electrode and a sustain electrode, an energy storing unit for recovering a voltage stored in the scan electrode and a voltage stored in the sustain electrode, a first energy recovery circuit unit for recovering the voltage stored in the scan electrode, for storing the recovered voltage in the energy storing unit, and for supplying the voltage stored in the energy storing unit to the scan electrode, and a second energy recovery circuit unit for recovering the voltage stored in the sustain electrode, for storing the recovered voltage in the energy storing unit, and for supplying the voltage stored in the energy storing unit to the sustain electrode.

In another aspect, there is provided a plasma display apparatus comprising a plasma display panel comprising a scan electrode and a sustain electrode, a first sustain pulse supply unit for supplying a first sustain pulse of a negative polarity to the scan electrode, a second sustain pulse supply unit for supplying a second sustain pulse of a negative polarity to the sustain electrode, the second sustain pulse of the negative polarity and the first sustain pulse of the negative polarity being alternately supplied, and an energy storing unit, commonly connected to the first sustain pulse supply unit and the second sustain pulse supply unit, for recovering a voltage stored in the scan electrode and a voltage stored in the sustain electrode and for supplying the recovered voltages to each of the scan electrode and the sustain electrode.

In still another aspect, there is provided a method of driving a plasma display apparatus comprising a scan electrode and a sustain electrode, comprising supplying a voltage stored in an energy storing unit to the scan electrode, supplying a sustain voltage of a negative polarity to the scan electrode, recovering a voltage stored in the scan electrode to store the recovered voltage in the energy storing unit, supplying a voltage stored in the energy storing unit to the sustain electrode, supplying the sustain voltage of the negative polarity to the sustain electrode, and recovering the voltage stored in the sustain electrode to store the recovered voltage in the energy storing unit.

### BRIEF DESCRIPTION OF THE DRAWINGS

The invention will be described in detail with reference to the following drawings in which like numerals refer to like elements.

FIGS. 1a and 1b illustrate an energy recovery circuit and a driving waveform of a related art plasma display apparatus;

FIG. 2 illustrates an example of the structure of a plasma display panel in a plasma display apparatus according to an embodiment of the present invention;

FIG. 3 illustrates an energy recovery circuit of the plasma display apparatus according to the embodiment of the present invention; and

FIGS. 4a and 4b are graphs of a sustain waveform and a current waveform of a capacitor generated by the plasma display apparatus according to the embodiment of the present invention.

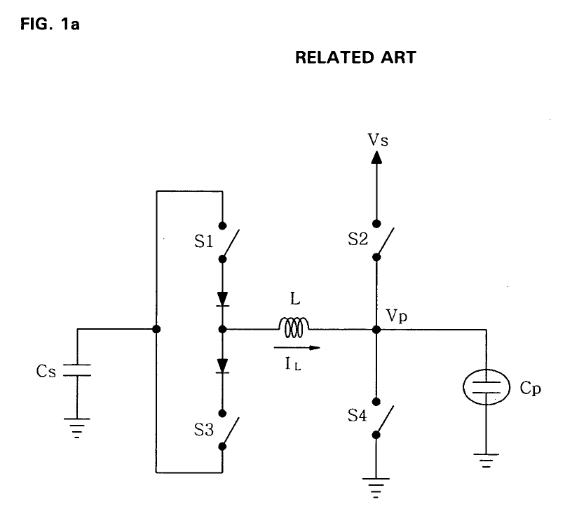

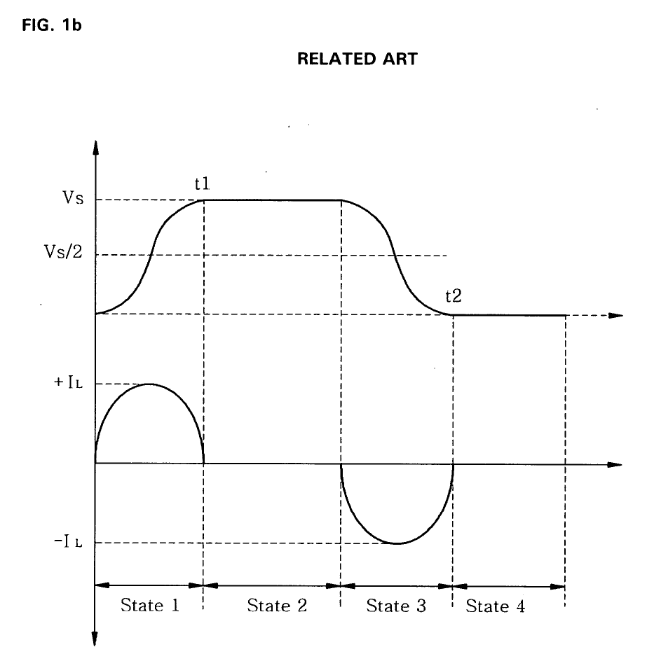

### DETAILED DESCRIPTION OF PREFERRED EMBODIMENTS

Preferred embodiments of the present invention will be described in a more detailed manner with reference to the drawings.

A plasma display apparatus according to embodiments of the present invention comprises a plasma display panel comprising a scan electrode and a sustain electrode, an energy storing unit for recovering a voltage stored in the scan electrode and a voltage stored in the sustain electrode, a first energy recovery circuit unit for recovering the voltage stored in the scan electrode, for storing the recovered voltage in the energy storing unit, and for supplying the voltage stored in the energy storing unit to the scan electrode, and a second energy recovery circuit unit for recovering the voltage stored in the sustain electrode, for storing the recovered voltage in the energy storing unit, and for supplying the voltage stored in the energy storing unit to the sustain electrode.

The voltage stored in each of the scan electrode and the sustain electrode may be equal to a sustain voltage of a negative polarity.

The energy storing unit may comprise a capacitor.

A distance between the scan electrode and the sustain electrode may substantially range from 100 μm to 400 μm.

A distance between the scan electrode and the sustain electrode may substantially range from 160 μm to 300 μm.

The energy storing unit may be commonly connected to the first energy recovery circuit unit and the second energy recovery circuit unit.

A plasma display apparatus according to the embodiments of the present invention comprises a plasma display panel comprising a scan electrode and a sustain electrode, a first sustain pulse supply unit for supplying a first sustain pulse of a negative polarity to the scan electrode, a second sustain pulse supply unit for supplying a second sustain pulse of a negative polarity to the sustain electrode, the second sustain pulse of the negative polarity and the first sustain pulse of the negative polarity being alternately supplied, and an energy storing unit, commonly connected to the first sustain pulse supply unit and the second sustain pulse supply unit, for recovering a voltage stored in the scan electrode and a voltage stored in the sustain electrode and for supplying the recovered voltages to each of the scan electrode and the sustain electrode.

The energy storing unit may comprise a capacitor.

The first sustain pulse supply unit may comprise a first energy recovery circuit unit for recovering the voltage stored in the scan electrode, for storing the recovered voltage in the energy storing unit and for supplying the voltage stored in the energy storing unit to the scan electrode, and a first sustain voltage supply unit for supplying a sustain voltage of a negative polarity to the scan electrode.

The second sustain pulse supply unit may comprise a second energy recovery circuit unit for recovering the voltage stored in the sustain electrode, for storing the recovered voltage in the energy storing unit and for supplying the voltage stored in the energy storing unit to the sustain electrode, and a second sustain voltage supply unit for supplying the sustain voltage of the negative polarity to the sustain electrode.

The first sustain voltage supply unit and the second sustain voltage supply unit may use the same sustain voltage source of a negative polarity.

A distance between the scan electrode and the sustain electrode may substantially range from 100 μm to 400 μm.

A distance between the scan electrode and the sustain electrode may substantially range from 160 μm to 300 μm.

A method of driving a plasma display apparatus comprising a scan electrode and a sustain electrode according to the embodiments of the present invention comprises supplying a voltage stored in an energy storing unit to the scan electrode, supplying a sustain voltage of a negative polarity to the scan electrode, recovering a voltage stored in the scan electrode to store the recovered voltage in the energy storing unit, supplying a voltage stored in the energy storing unit to the sustain electrode, supplying the sustain voltage of the negative polarity to the sustain electrode, and recovering the voltage stored in the sustain electrode to store the recovered voltage in the energy storing unit.

The energy storing unit may comprise a capacitor.

A distance between the scan electrode and the sustain electrode may substantially range from 100 μm to 400 μm.

A distance between the scan electrode and the sustain electrode may substantially range from 160 μm to 300 μm.

Hereinafter, exemplary embodiments of the present invention will be described in detail with reference to the attached drawings.

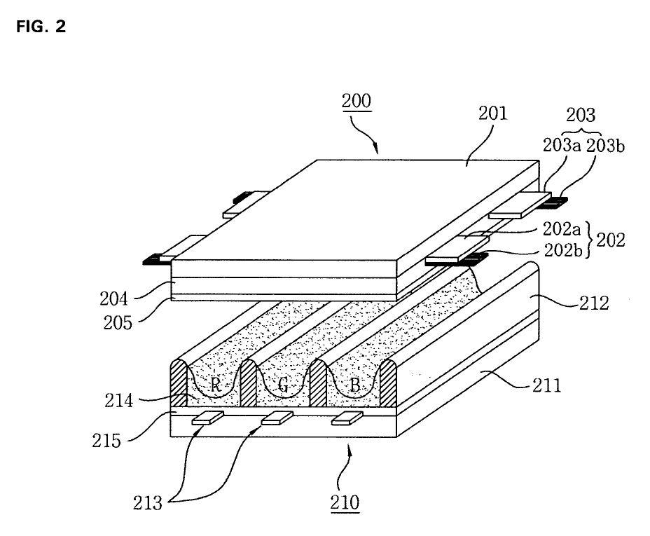

FIG. 2 illustrates an example of the structure of a plasma display panel in a plasma display apparatus according to an embodiment of the present invention.

As illustrated in FIG. 2, the plasma display panel of the plasma display apparatus according to the embodiment of the present invention comprises a front panel 200 and a rear panel 210 which are coupled in parallel to oppose to each other at a given distance therebetween. The front panel 200 comprises a front substrate 201 which is a display surface. The rear panel 210 comprises a rear substrate 211 constituting a rear surface. A plurality of scan electrodes 202 and a plurality of sustain electrodes 203 are formed in pairs on the front substrate 201, on which an image is displayed. A plurality of address electrodes 213 are arranged on the rear substrate 211 to intersect the scan electrodes 202 and the sustain electrodes 203.

The scan electrode 202 and the sustain electrode 203 each comprise transparent electrodes 202a and 203a made of transparent indium-tin-oxide (ITO) material and bus electrodes 202b and 203b made of a metal material. The scan electrode 202 and the sustain electrode 203 generate a mutual discharge therebetween in one discharge cell and maintain light-emissions of the discharge cells.

The scan electrode 202 and the sustain electrode 203 are covered with one or more upper dielectric layers 204 to limit a discharge current and to provide insulation between the scan electrode 202 and the sustain electrode 203. A protective layer 205 with a deposit of MgO is formed on an upper surface of the upper dielectric layer 204 to facilitate discharge conditions.

A plurality of stripe-type (or well-type) barrier ribs 212 are formed in parallel on the rear substrate 211 of the rear panel 210 to form a plurality of discharge spaces (i.e., a plurality of discharge cells). The plurality of address electrodes 213 for performing an address discharge to generate vacuum ultraviolet rays are arranged in parallel to the barrier ribs 212.

An upper surface of the rear substrate 211 is coated with Red (R), green (G) and blue (B) phosphors 214 for emitting visible light for an image display when an address discharge is performed. A lower dielectric layer 215 is formed between the address electrodes 213 and the phosphors 214 to protect the address electrodes 213.

An example of the plasma display panel applicable to the embodiment of the present invention was illustrated in FIG. 2. Accordingly, the embodiment of the present invention is not limited to the structure of the plasma display panel illustrated in FIG. 2.

For example, in FIG. 2, the scan electrode 202 and the sustain electrode 203 each comprise the transparent electrode and the bus electrode. However, at least one of the scan electrode 202 and the sustain electrode 203 may comprise either the bus electrode or the transparent electrode.

Further, the structure of the plasma display panel, in which the front panel 200 comprises the scan electrode 202 and the sustain electrode 203 and the rear panel 210 comprises the address electrode 213, is illustrated in FIG. 2. However, the front panel 200 may comprise all of the scan electrode 202, the sustain electrode 203 and the address electrode 213. At least one of the scan electrode 202, the sustain electrode 203 and the address electrode 213 may be formed on the barrier rib 212.

Considering the structure of the plasma display panel 100 of FIG. 2, the plasma display panel applicable to the embodiment of the present invention has only to comprise the scan electrode 202, the sustain electrode 203 and the address electrode 213. Accordingly, the plasma display panel may have various structures except the above-described structural characteristic.

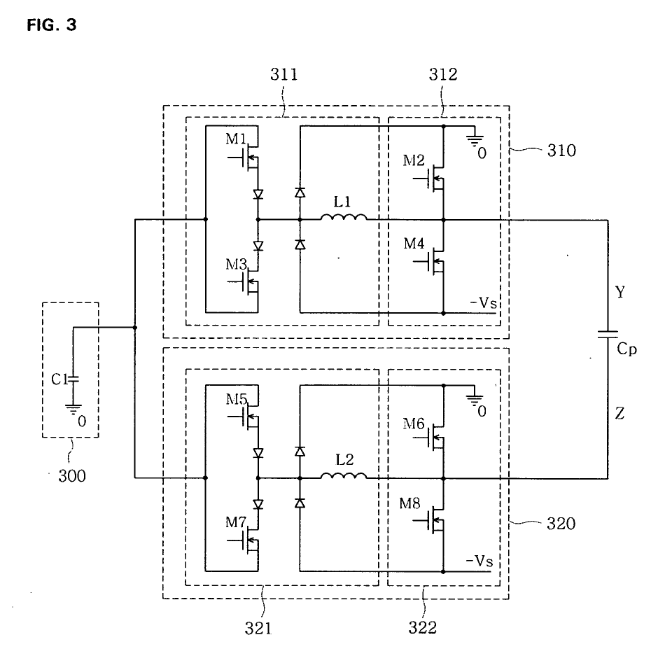

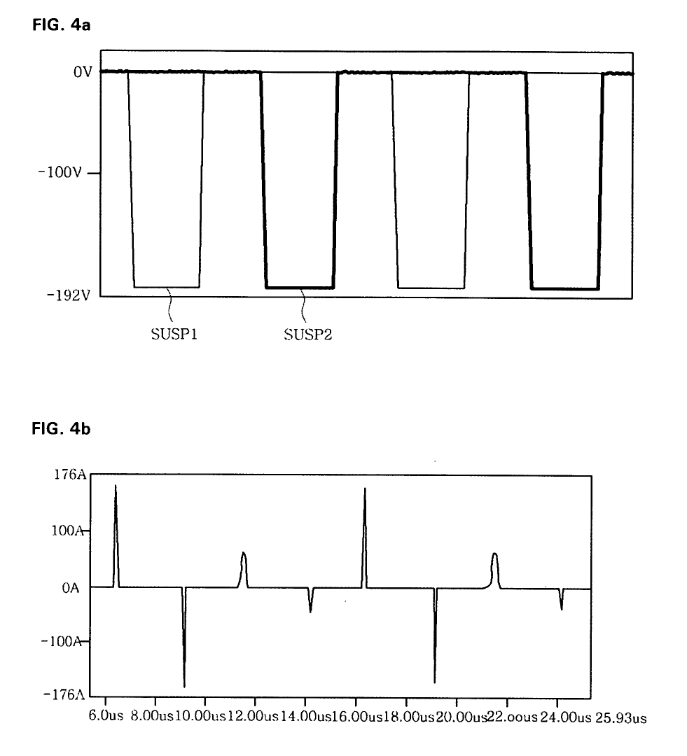

FIG. 3 illustrates an energy recovery circuit of the plasma display apparatus according to the embodiment of the present invention. FIGS. 4a and 4b are graphs of a sustain waveform and a current waveform of a capacitor generated by the plasma display apparatus according to the embodiment of the present invention

As illustrated in FIG. 3, the plasma display apparatus according to the embodiment of the present invention comprises a plasma display panel Cp, an energy storing unit 300, a first sustain pulse supply unit 310 and a second sustain pulse supply unit 320.

The energy storing unit 300 comprises at least one capacitor C1. The energy storing unit 300 is commonly connected to a fist energy recovery circuit unit 311 of the first sustain pulse supply unit 310 and a second energy recovery circuit unit 321 of the second sustain pulse supply unit 320, thereby storing an energy.

The first sustain pulse supply unit 310 comprises the first energy recovery circuit unit 311 and a first sustain voltage supply unit 312. The first sustain pulse supply unit 310 supplies a first sustain pulse SUS1 of a negative polarity (refer to FIG. 4a) to the scan electrode Y of the plasma display panel Cp.

The first energy recovery circuit unit 311 comprises a first switch M1, a third switch M3 and a first inductor L1. The first energy recovery circuit unit 311 is connected between the energy storing unit 300 and the first sustain voltage supply unit 312. The first energy recovery circuit unit 311 recovers the energy stored in the scan electrode Y of the plasma display panel Cp such that the recovered energy is stored in the energy storing unit 300. The energy stored in the energy storing unit 300 is again supplied to the scan electrode Y of the plasma display panel Cp.

The first sustain voltage supply unit 312 comprises a second switch M2, a fourth switch M4 and a negative sustain voltage source (not shown). The first sustain voltage supply unit 312 is connected between the plasma display panel Cp and the first energy recovery circuit unit 311. The first sustain voltage supply unit 312 supplies a sustain voltage −Vs of a negative polarity to the scan electrode Y of the plasma display panel Cp.

The second sustain pulse supply unit 320 comprises the second energy recovery circuit unit 321 and a second sustain voltage supply unit 322. The second sustain pulse supply unit 320 supplies a second sustain pulse SUS2 of a negative polarity (refer to FIG. 4a) to the sustain electrode Z of the plasma display panel Cp.

The second energy recovery circuit unit 321 comprises a fifth switch M5, a seventh switch M7 and a second inductor L2. The second energy recovery circuit unit 321 is connected between the energy storing unit 300 and the second sustain voltage supply unit 322. The second energy recovery circuit unit 321 recovers the energy stored in the sustain electrode Z of the plasma display panel Cp such that the recovered energy is stored in the energy storing unit 300. The energy stored in the energy storing unit 300 is again supplied to the sustain electrode Z of the plasma display panel Cp.

The second sustain voltage supply unit 322 comprises a sixth switch M6, an eighth switch M8 and a negative sustain voltage source (not shown). The second sustain voltage supply unit 322 is connected between the plasma display panel Cp and the second energy recovery circuit unit 321. The second sustain voltage supply unit 322 supplies a sustain voltage −Vs of a negative polarity to the sustain electrode Z of the plasma display panel Cp.

The following is a detailed description of an operation of the plasma display apparatus of the above-described configuration.

Operations of the first energy recovery circuit unit 311 and the first sustain voltage supply unit 312 of the first sustain pulse supply unit 310 will be described in detail.

The first switch M1 is turned on and the second to fourth switches M2 to M4 are turned off. As a result, the energy stored in the capacitor C1 of the energy storing unit 300 is supplied to the scan electrode Y of the plasma display panel Cp such that a voltage of the scan electrode Y gradually falls to the sustain voltage −Vs of the negative polarity.

Next, the first switch M1 and the fourth switch M4 are turned on and the second switch M2 and the third switch M3 are turned off As a result, the sustain voltage −Vs of the negative polarity is supplied to the scan electrode Y of the plasma display panel Cp such that a voltage of the scan electrode Y is maintained at the sustain voltage −Vs of the negative polarity.

Next, the third switch M3 is turned on and the first, second and fourth switches M1, M2 and M4 are turned off. As a result, the energy stored in the scan electrode Y of the plasma display panel Cp is discharged to the capacitor C1 of the energy storing unit 300. In other words, the capacitor C1 of the energy storing unit 300 recovers the energy stored in the scan electrode Y of the plasma display panel Cp such that a voltage of the scan electrode Y gradually rises to a ground level voltage.

Finally, the second switch M2 is turned on and the fist, third and fourth switches M1, M3 and M4 are turned off As a result, the ground level voltage is supplied to the scan electrode Y of the plasma display panel Cp such that a voltage of the scan electrode Y is maintained at the ground level voltage.

Since operations of the second energy recovery circuit unit 321 and the second sustain voltage supply unit 322 of the second sustain pulse supply unit 320 are the same as the operations of the first energy recovery circuit unit 311 and the first sustain voltage supply unit 312 of the first sustain pulse supply unit 310, a description thereof is omitted.

In the plasma display apparatus according to the embodiment of the present invention, when a sustain discharge occurs between the scan electrode and the sustain electrode, capacitors for recovering the reactive energy of each of the scan electrode and the sustain electrode of the plasma display panel are integrated into one capacitor, i.e., the capacitor C1. It can be seen from a simulation result of FIGS. 4a and 4b that the capacitor C1 of the energy storing unit 300 recovers the reactive energy of each of the scan electrode and the sustain electrode.

It is possible to apply the plasma display apparatus according to the embodiment of the present invention to a plasma display apparatus having a long-gap structure m which a distance between a scan electrode and a sustain electrode is long.

When applying the plasma display apparatus according to the embodiment of the present invention to a plasma display apparatus having a long-gap structure, in which a distance between a scan electrode and a sustain electrode substantially ranges from 100 μm to 400 μm, for improving discharge efficiency and stabilizing a driving characteristic, the plasma display apparatus having the long-gap structure is driven more efficiently and more stably.

Preferably, a distance between the scan electrode and the sustain electrode substantially ranges from 160 μm to 300 μm.

The embodiment of the present invention simplifies the configuration of the circuit and reduces the cost.

It will be obvious that the embodiments of the present invention being thus described may be varied in many ways. Such variations are not to be regarded as a departure from the spirit and scope of the invention, and all such modifications as would be obvious to one skilled in the art are intended to be included within the scope of the following claims.

What is claimed is:

1. A plasma display apparatus comprising:
a plasma display panel comprising a scan electrode and a sustain electrode;
an energy storing unit for recovering a voltage stored in the scan electrode and a voltage stored in the sustain electrode;
a first energy recovery circuit unit for recovering the voltage stored in the scan electrode, for storing the recovered voltage in the energy storing unit, and for supplying the voltage stored in the energy storing unit to the scan electrode; and
a second energy recovery circuit unit for recovering the voltage stored in the sustain electrode, for storing the recovered voltage in the energy storing unit, and for supplying the voltage stored in the energy storing unit to the sustain electrode.

2. The plasma display apparatus of claim 1, wherein the voltage stored in each of the scan electrode and the sustain electrode is equal to a sustain voltage of a negative polarity.

3. The plasma display apparatus of claim 1, wherein the energy storing unit comprises a capacitor.

4. The plasma display apparatus of claim 1, wherein a distance between the scan electrode and the sustain electrode substantially ranges from 100 μm to 400 μm.

5. The plasma display apparatus of claim 4, wherein a distance between the scan electrode and the sustain electrode substantially ranges from 160 μm to 300 μm.

6. The plasma display apparatus of claim 1, wherein the energy storing unit is commonly connected to the first energy recovery circuit unit and the second energy recovery circuit unit.

7. A plasma display apparatus comprising:
a plasma display panel comprising a scan electrode and a sustain electrode;
a first sustain pulse supply unit for supplying a first sustain pulse of a negative polarity to the scan electrode;
a second sustain pulse supply unit for supplying a second sustain pulse of a negative polarity to the sustain electrode, the second sustain pulse of the negative polarity and the first sustain pulse of the negative polarity being alternately supplied; and
an energy storing unit, commonly connected to the first sustain pulse supply unit and the second sustain pulse supply unit, for recovering a voltage stored in the scan electrode and a voltage stored in the sustain electrode and for supplying the recovered voltages to each of the scan electrode and the sustain electrode.

8. The plasma display apparatus of claim 7, wherein the energy storing unit comprises a capacitor.

9. The plasma display apparatus of claim 7, wherein the first sustain pulse supply unit comprises a first energy recovery circuit unit for recovering the voltage stored in the scan electrode, for storing the recovered voltage in the energy storing unit and for supplying the voltage stored in the energy storing unit to the scan electrode, and a first sustain voltage supply unit for supplying a sustain voltage of a negative polarity to the scan electrode.

10. The plasma display apparatus of claim 9, wherein the second sustain pulse supply unit comprises a second energy recovery circuit unit for recovering the voltage stored in the sustain electrode, for storing the recovered voltage in the energy storing unit and for supplying the voltage stored in the energy storing unit to the sustain electrode, and a second sustain voltage supply unit for supplying the sustain voltage of the negative polarity to the sustain electrode.

11. The plasma display apparatus of claim 10, wherein the first sustain voltage supply unit and the second sustain voltage supply unit use the same sustain voltage source of a negative polarity.

12. The plasma display apparatus of claim 7, wherein a distance between the scan electrode and the sustain electrode substantially ranges from 100 μm to 400 μm.

13. The plasma display apparatus of claim 12, wherein a distance between the scan electrode and the sustain electrode substantially ranges from 160 μm to 300 μm.

14. A method of driving a plasma display apparatus comprising a scan electrode and a sustain electrode, comprising:
supplying a voltage stored in an energy storing unit to the scan electrode;
supplying a sustain voltage of a negative polarity to the scan electrode;
recovering a voltage stored in the scan electrode to store the recovered voltage in the energy storing unit;
supplying a voltage stored in the energy storing unit to the sustain electrode;
supplying the sustain voltage of the negative polarity to the sustain electrode; and
recovering the voltage stored in the sustain electrode to store the recovered voltage in the energy storing unit.

15. The method of claim 14, wherein the energy storing unit comprises a capacitor.

16. The method of claim 14, wherein a distance between the scan electrode and the sustain electrode substantially ranges from 100 μm to 400 μm.

17. The method of claim 16, wherein a distance between the scan electrode and the sustain electrode substantially ranges from 160 μm to 300 μm.
